(19) United States
(12) Patent Application Publication
(10) Pub. No.: US 2003/0043481 A1
(43) Pub. Date: Mar. 6, 2003

(54) Blindview mirror

(76) Inventor: Todd Randolph DeHart, Lusby, MD (US)

Correspondence Address: A.A.G. Incorporated, 12070 Susan Lane, Lusby, MD, 20657, US

(21) Appl. No.: 10/213,187

(22) Filed: Aug. 6, 2002

Related U.S. Application Data
(60) Provisional application No. 60/317,018, filed on Sep. 5, 2001.

(51) Int. Cl. G02B 5/08; G02B 7/182

(52) U.S. Cl. 359/854; 359/865

(57) ABSTRACT

The Blindview Mirror invention enhances motor vehicle safety by allowing drivers the ability to scan his or her blind spot even with incorrectly adjusted side mirrors. This device helps drivers make safer decisions prior to high speed lane changes.

### CROSS-REFERENCE TO RELATED APPLICATIONS

Provisional Application Number: 60/317,018

Title: Blindview Mirror

Filing Date: Sep. 5, 2001

Confirmation Number: 3715

### STATEMENT REGARDING FEDERALLY SPONSORED RESEARCH OR

DEVELOPMENT:

Not Applicable

### REFERENCE TO SEQUENCE LISTING, A TABLE, OR A COMPUTER PROGRAM LISTING COMPACT DISK APPENDIX:

Not Applicable

### BACKGROUND OF THE INVENTION

This invention pertains to motor vehicle safety. The Blindview Mirror invention specifically applies to the area of mirrored device usage by the operator of a motor vehicle during high speed lane changes. The invention addresses a typical failure of motor vehicle operators to adjust the left side vehicle mirror into vehicle bind spots or augments the operators ability to project vision into vehicle blind spots depending on the skill and knowledge of the operator. See FIGS. 4 and 5.

The primary benefit of the Blindview Mirror is the left side tab which projects vision into the classic left side vehicle blind spot, where a high speed lane change is most likely to interact with another vehicle in close proximity. It is more intuitive for drivers to adjust the left tab of a Blindview Mirror appropriately vs the standard left outside mirror. Use of the Blindview Mirror also keeps the driver in a more forward looking heads-up position.

### BRIEF DESCRIPTION OF THE SEVERAL VIEWS OF THE DRAWING

FIG. 1.: Front View. This figure illustrates looking straight at the mirrored surfaces of a Blindview Mirror with the normal rearview mirror in the center and a mirrored tab on each end.

FIG. 2.: Top View. This figure illustrates looking down on a Blindview Mirror, again with the normal rearview mirror section in the center and tabs on both ends.

FIG. 3.: Blindview Mirror Function. This figure illustrates the general areas of projected vision created by a Blindview Mirror for the operator of a motor vehicle.

FIG. 4.: Typical Driver Left Side Mirror Adjustment. This figure illustrates how most motor vehicle drivers adjust their left side mirror to see more behind them instead of deeper into the left vehicle blind spot.

FIG. 5.: Correct Driver Left Side Mirror Adjustment. This figure illustrates the correct setting for a left side mirror.

### DETAILED DESCRIPTION OF THE INVENTION

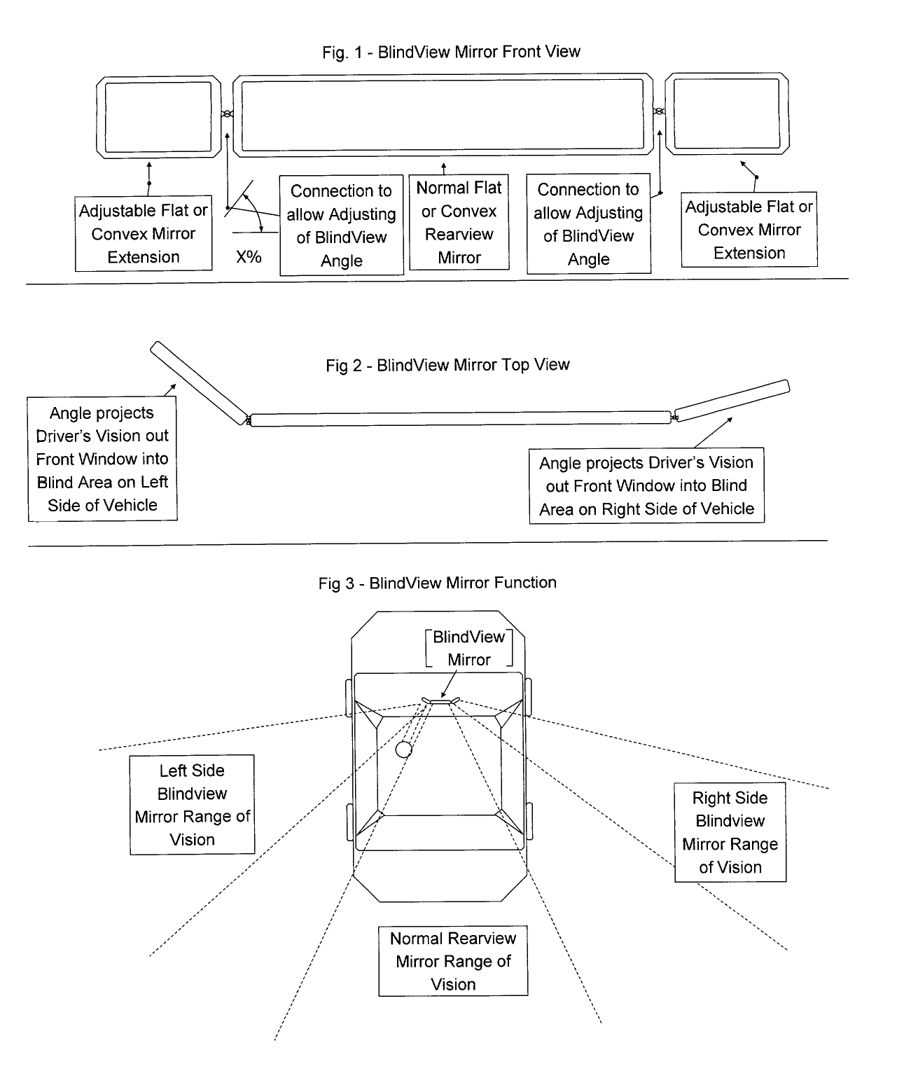

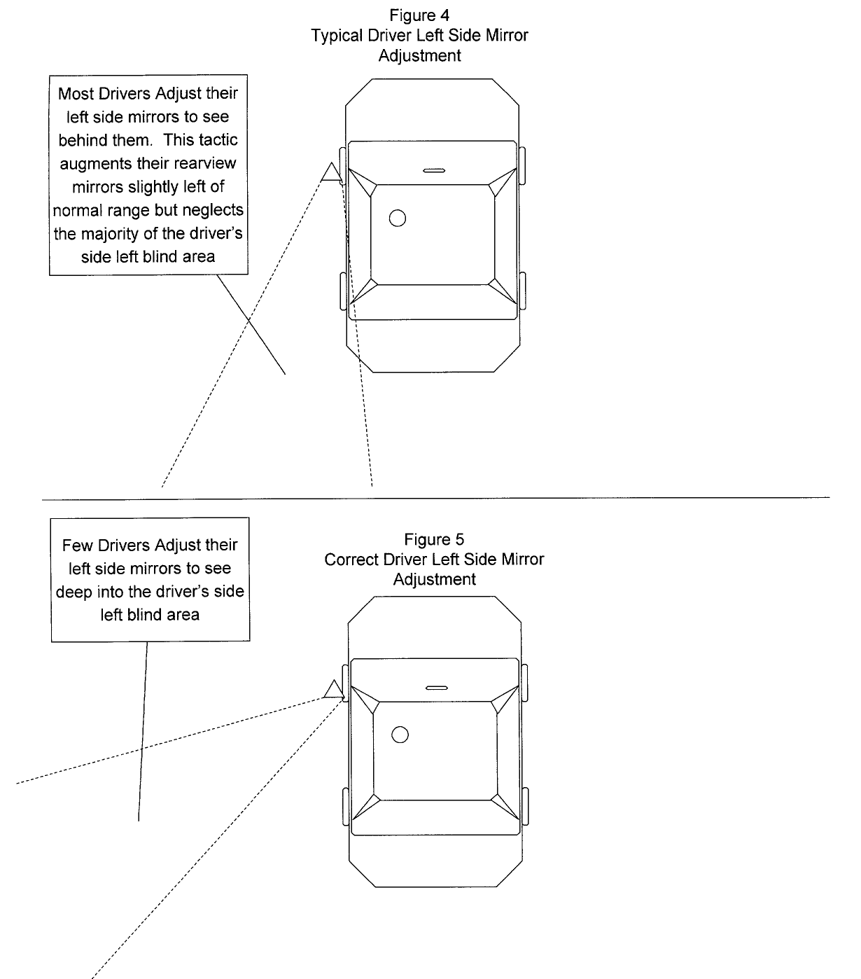

You create a Blindview Mirror by adding one or more mirrored tabs or extensions to a standard rearview mirror. See drawing FIGS. 1 and 2. The mirrored tabs my be of flat or convex design and must be independently adjustable at the connection to the standard rearview mirror. Although the tabs my be attached to any part of the rearview mirror, the best mode is to attach extensions to the immediate left and right sides of a standard rearview mirror. The right side tab may optionally be omitted, as it is not as critical and beneficial as the left side tab.

A motor vehicle operator uses a Blindview Mirror by adjusting the left tab to project his or her vision through the left side front window into the vehicles left blind spot. (See FIG. 3.) Similarly, if a right side tab is installed, the operator adjusts the right side tab to project vision through the right front window toward the right side of the vehicle.

I claim:

1. A Blindview Mirror is created by affixing one or more adjustable mirrored tabs or extensions to a standard rearview mirror.
